(19) United States
(12) Patent Application Publication
(10) Pub. No.: US 2025/0095112 A1
(43) Pub. Date: Mar. 20, 2025

(54) IMAGE PROCESSING METHOD AND APPARATUS, DEVICE, AND MEDIUM

(71) Applicant: Beijing Zitiao Network Technology Co., Ltd., Haidian District, Beijing (CN)

(72) Inventors: Lang CHEN, Beijing (CN); Siyu ZHOU, Beijing (CN)

(21) Appl. No.: 18/728,209

(22) PCT Filed: Jan. 13, 2023
(86) PCT No.: PCT/CN2023/072054

§ 371 Date: Jul. 11, 2024

(30) Foreign Application Priority Data
Jan. 25, 2022 (CN) 202210089956.8

(51) Int. Cl. G06T 5/60; G06T 11/00

(52) U.S. Cl. CPC G06T 5/60; G06T 11/001; G06T 2207/20081

(57) ABSTRACT

Embodiments of the present disclosure relate to an image processing method and apparatus, a device, and a medium. The method includes: training to generate a first image generator, and training to generate a second image generator, the second image generator being configured to process an input random feature vector to generate a target object image with a second style; respectively processing an input sample feature vector on the basis of the first image generator and the second image generator, to generate a sample image with a first style and a sample image with the second style as paired sample data; and training, on the basis of the paired sample data, a preset model to generate a target image generator, wherein the target image generator is configured to process an input image with the first style to generate an output image with the second style.

### CROSS-REFERENCE TO RELATED APPLICATIONS

The present application is based on and claims priority to China Patent Application No. 202210089956.8 filed on Jan. 25, 2022, the disclosure of which is incorporated by reference herein in its entirety.

### TECHNICAL FIELD

The present disclosure relates to the field of image processing technology, and particularly to an image processing method, an apparatus, a device, and a medium.

### BACKGROUND

Style conversion of a captured image for a target object has become a popular demand among image processing users. In related art, an image processing application provides various editing controls for image parameters, such as editing controls for brightness processing, sticker addition processing, makeup conversion processing, etc. A user can adjust image parameters by performing an editing operation with the editing control to achieve style conversion of the image.

### SUMMARY

An embodiment of the present disclosure provides an image processing method, comprising: generating a first image generator by training, and generating a second image generator by training, wherein the first image generator is configured to process an input random feature vector to generate a target object image with a first style, and the second image generator is configured to process the input random feature vector to generate a target object image with a second style; processing an input sample feature vector based on the first image generator and the second image generator to generate a sample image with the first style and a sample image with the second style as paired sample data; and training a preset model based on the paired sample data to generate a target image generator, wherein the target image generator is configured to process an input image with the first style to generate an output image with the second style.

An embodiment of the present disclosure further provides an image processing apparatus, comprising: a training module configured to generate a first image generator by training, and generate a second image generator by training, wherein the first image generator is configured to process an input random feature vector to generate a target object image with a first style, and the second image generator is configured to process the input random feature vector to generate a target object image with a second style; a sample generation module configured to process an input sample feature vector based on the first image generator and the second image generator to generate a sample image with the first style and a sample image with the second style as paired sample data; and an image generator generation module configured to train a preset model based on the paired sample data to generate a target image generator, wherein the target image generator is configured to process an input image with the first style to generate an output image with the second style.

An embodiment of the present disclosure provides an electronic device, comprising: a processor; and a memory configured to store executable instructions for the processor; wherein the processor is configured to read the executable instructions from the memory and execute the executable instructions to implement the image processing method provided in the embodiments of the present disclosure.

An embodiment of the present disclosure further provides a computer-readable storage medium on which a computer program is stored, wherein the computer program is configured to perform the image processing method provided in the embodiments of the present disclosure.

An embodiment of the present disclosure further provides a computer program, comprising: instructions that, when executed by a processor, cause the processor to perform the image processing method provided in the embodiments of the present disclosure.

### BRIEF DESCRIPTION OF THE DRAWINGS

The above and other features, advantages, and aspects of the embodiments of the present disclosure will become more apparent from the following embodiments with reference to the drawings. Throughout the drawings, the same or similar reference signs indicate the same or similar elements. It should be understood that the drawings are schematic and the components and elements are not necessarily drawn to scale.

FIG. 1 is a flowchart of an image processing method provided by an embodiment of the present disclosure;

FIG. 2 is a flowchart of another image processing method provided by an embodiment of the present disclosure;

FIG. 3 is a schematic diagram of an image processing scene provided by an embodiment of the present disclosure;

FIG. 4 is a schematic diagram of another image processing scene provided by an embodiment of the present disclosure;

FIG. 5 is a schematic diagram of another image processing scene provided by an embodiment of the present disclosure;

FIG. 6 is a schematic diagram of another image processing scene provided by an embodiment of the present disclosure;

FIG. 7 is a flowchart of another image processing method provided by an embodiment of the present disclosure;

FIG. 8 is a flowchart of another image processing method provided by an embodiment of the present disclosure;

FIG. 9 is a flowchart of another image processing method provided by an embodiment of the present disclosure;

FIG. 10 is a schematic structural diagram of an image processing apparatus provided by an embodiment of the present disclosure;

FIG. 11 is a schematic structural diagram of an electronic device provided by an embodiment of the present disclosure.

### DETAILED DESCRIPTION

Embodiments of the present disclosure will be described in detail below with reference to the accompanying drawings. Although some embodiments of the present disclosure are shown in the accompanying drawings, it should be understood that the present disclosure can be implemented in various forms, and should not be construed as being limited to the embodiments set forth herein. On the contrary, these embodiments are provided for a more thorough and complete understanding of the present disclosure. It should be understood that the drawings and embodiments of the present disclosure are only used for exemplary purposes, and are not used to limit the scope of protection of the present disclosure.

It should be understood that the various steps described in the methods of the embodiments of the present disclosure may be executed in a different order, and/or executed in parallel. In addition, the methods may comprise additional steps and/or some of the illustrated steps may be omitted. The scope of the present disclosure is not limited in this regard.

The term “comprising” and its variants as used herein is an open-ended mode expression, that is, “comprising but not limited to”. The term “based on” means “based at least in part on”. The term “one embodiment” means “at least one embodiment”; the term “another embodiment” means “at least one additional embodiment”; and the term “some embodiments” means “at least some embodiments”. Related definitions of other terms will be given in the following description.

It should be noted that the concepts of “first”, “second” and the like mentioned in the present disclosure are only used to distinguish different devices, modules or units, and are not used to limit the order of functions performed by these devices, modules or units, or interdependence therebetween.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

The inventors of the present disclosure have found that in the related art, the way to implement image style conversion by adjusting an editing control by a user depends on a manual operation of the user, which makes it difficult to ensure the conversion effect and has low conversion efficiency.

In view of the above, the present disclosure provides an image processing method for solving, to the greatest extent possible, the problems of difficulty in ensuring the conversion effect and low conversion efficiency when performing style conversion on images in related art.

An embodiment of the present disclosure provides an image processing method in which an image generator for generating an image with a first style and an image generator for generating an image with a second style are trained; paired sample data are then generated based on these two image generators to obtain training sample data with good quality. A target image generator for style conversion is obtained by training based on the training sample data.

Therefore, even in some scenes where it is difficult to obtain an object image with the first style and a corresponding image with the second style as training data, sample image pairs with the second style can still be obtained based on the above image generators, thus overcoming the problem of difficult sample acquisition in the training process of a style conversion model as much as possible and ensuring the effect and efficiency of style conversion.

The method will be described below in conjunction with a specific embodiment.

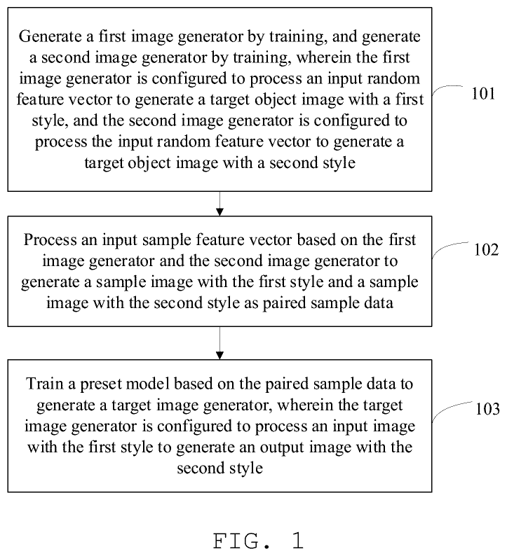

FIG. 1 is a flowchart of an image processing method provided by an embodiment of the present disclosure. The method can be performed by an image processing apparatus, wherein the apparatus can be implemented by software and/or hardware, and can generally be integrated in an electronic device. As shown in FIG. 1, the method comprises steps S101 to S103.

In step 101, a first image generator is generated by training, and a second image generator is generated by training, wherein the first image generator is configured to process an input random feature vector to generate a target object image with a first style, and the second image generator is configured to process the input random feature vector to generate a target object image with a second style.

For example, the target can be a human being, an animal, etc., which is not specifically limited here. The input random feature vector comprises, but is not limited to, a contour feature, a pixel color feature, or the like. For example, the input random feature vector comprises at least one of a contour feature or a pixel color feature. The first style and the second style may be any different style information. For example, the first style can be “plain style face”, the second style can be “Hong Kong style face”, etc.

In some embodiments, in order to ensure robustness of the first image generator, first object image data with the first style is randomly collected based on a plurality of first preset indicators. The plurality of first preset indicators correspond to a plurality of feature dimensions of a target object to ensure the robustness of the training of the first image generator. For example, in response to the target object being a human face, the first preset indicators corresponding to the target object comprise a facial angle indicator type, a facial age indicator type, a facial temperament indicator type, a facial contour indicator type, a facial brightness indicator type, etc. Each indicator type can comprise a plurality of indicator values to ensure that the facial sample data obtained based on the plurality of first preset indicators can not only cover a plurality of indicator types, but also have different indicator values in a same indicator type (such as having different facial angles, etc.).

In some embodiments, a parameter of a generative adversarial network is trained based on the first object image data to obtain the first image generator. The first image generator can obtain a target object image with a first style based on an input random feature vector.

In some embodiments, an input random feature vector can also be trained to generate a second image generator for generating a target object image with a second style. The random feature vector comprises, but is not limited to, a contour feature, a pixel color feature, etc.

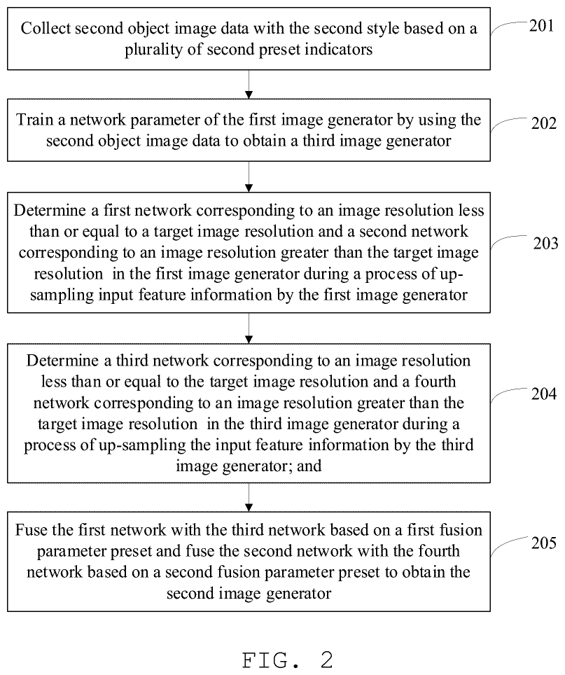

In an embodiment of the present disclosure, as shown in FIG. 2, the generating of the second image generator by training comprises steps 201 to 205.

In step 201, second object image data with the second style is collected based on a plurality of second preset indicators.

In order to ensure robustness of the second image generator, the second object image data with the second style is collected based on the plurality of second preset indicators. The plurality of second preset indicators can correspond to a plurality of different dimensions of the second object image data. For example, in response to the second object image data corresponding to a human face, the second preset indicators corresponding to the second object image data can comprise a facial angle indicator type, a facial age indicator type, a facial temperament indicator type, a facial contour indicator type, a facial brightness indicator type, etc. Each indicator type can comprise a plurality of indicator values to ensure that the second object image data obtained based on the plurality of second preset indicators can not only cover a plurality of indicator types, but also have different indicator values in a same indicator type (such as having different facial angles, etc.).

It should be noted that the input random feature vector described above can be randomly generated. For example, the input random feature vector is a vector of any dimension generated based on a random algorithm and having a first style feature or a second style feature. The input random feature vector can also be extracted based on the target object image with the first style or the second style. A random feature vector extracted based on a real target object image can ensure that the image output by the first image generator and the second image generator obtained by training is more realistic.

It should also be noted that the second object image data described above can be randomly generated. For example, the second object image data is a facial feature of any dimension generated based on a random algorithm. The second object image data can also be extracted based on a real target object image. The second object image data extracted based on the real target object image can ensure that the image output by the image generator obtained by training is more realistic.

In step 202, a network parameter of the first image generator is trained by using the second object image data to obtain a third image generator.

In some embodiments, a parameter of a generative adversarial network is trained based on the second object image data to obtain a first image generator. The first image generator can obtain a target object image with a first style corresponding to an input random feature vector based on the input random feature vector. A third image generator is obtained by training. The third image generator can be configured to output a target object image with the first style based on an input feature vector.

In step 203, a first network corresponding to an image resolution less than or equal to a target image resolution and a second network corresponding to an image resolution greater than the target image resolution in the first image generator are determined during a process of up-sampling input feature information by the first image generator.

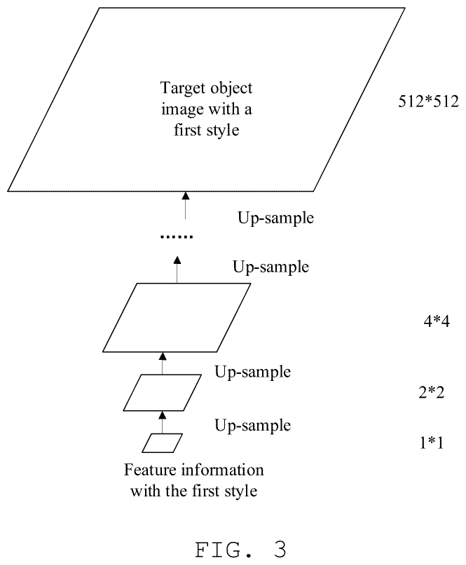

In the embodiment, it can be understood that the first image generator samples layer by layer based on the input feature information to obtain an object image with a first style. For example, as shown in FIG. 3, if the input feature information is feature information with an 1*1 resolution, a network parameter in a first layer of the first image generator allows up-sampling of the feature information to obtain feature information with a 2*2 resolution. A network parameter in a second layer further allows up-sampling of the feature information to obtain feature information with a 4*4 resolution. By up-sampling step by step, the corresponding up-sampled target object image (with a 512*512 resolution in the figure) is obtained.

Similarly, the third image generator samples layer by layer based on the input feature information to obtain an object image with the second style. For example, as shown in FIG. 4, if the input feature information is feature information with an 1*1 resolution, a network parameter in a first layer of the third image generator allows up-sampling of the feature information to obtain feature information with a 2*2 resolution. A network parameter in a second layer allows further up-sampling of the feature information to obtain feature information with a 4*4 resolution. By up-sampling step by step, the corresponding up-sampled target object image (with a 512*512 resolution in the figure) with the second style is obtained.

In the embodiment, in order to ensure the similarity between the output target object image with the second style and the output target face image with the first style, and to ensure a good experience of image style conversion, that is to say, in order to ensure that the converted target object image with the second style is more similar to the input target object image with the first style in subsequent style conversion, for example, if the input target object image is a face image of user A, in order to ensure that the output target object image is a face image with the second style which has facial features similar to that of user A, the first image generator and the third image generator are fused to obtain a second image generator.

However, in the fusion process, fusion parameters between different resolutions are different, which leads to different image generation effects of the second image generator. In the embodiment, a target image resolution corresponding to a fusion boundary layer is determined based on experimental data. Based on the target image resolution, the fusion of the image generator is performed to obtain a second image generator with better image conversion effect.

In the embodiment, a first network corresponding to an image resolution less than or equal to a target image resolution and a second network corresponding to an image resolution greater than the target image resolution in the first image generator are determined during a process of up-sampling input feature information by the first image generator. For example, if the target image resolution is 16*16, a first network corresponding to a resolution less than or equal to 16*16 and a second network corresponding to a resolution greater than 16*16 are determined.

In step 204, a third network corresponding to an image resolution less than or equal to the target image resolution and a fourth network corresponding to an image resolution greater than the target image resolution in the third image generator are determined during a process of up-sampling the input feature information by the third image generator.

In the embodiment, the third network corresponding to an image resolution less than or equal to the target image resolution and the fourth network corresponding to an image resolution greater than the target image resolution in the third image generator are determined during a process of up-sampling the input feature information by the third image generator. For example, if the target image resolution is 16*16, a third network corresponding to a resolution less than or equal to 16*16 and a fourth network corresponding to a resolution greater than 16*16 are determined.

In step 205, the first network is fused with the third network based on a first fusion parameter preset and the second network is fused with the fourth network based on a second fusion parameter preset to obtain the second image generator.

In the embodiment, the first network and the third network are fused according to the first fusion parameter preset, and the second network and the fourth network are fused according to the second fusion parameter preset. The network fusion with different resolutions is performed based on different fusion parameters, resulting in better style conversion effect of the fused second image generator. The first fusion parameter and the second fusion parameter can be any fusion parameters that take into account both the first style and the second style based on the input feature vector. Different fusion parameters correspond to different degrees of fusion. For example, the first fusion parameter and the second fusion parameter may have different types of fusion parameters and weight values.

In different application scenes, the methods for network fusion based on the fusion parameter may be different. In some possible embodiments, network output results at a corresponding resolution can be fused based on corresponding fusion parameters. In other possible embodiments, the network parameter weights in the corresponding networks can be modified based on the fusion parameters, output results at a corresponding resolution can be obtained based on the modified network parameters, and the output results of different image generators at the same resolution can then be fused.

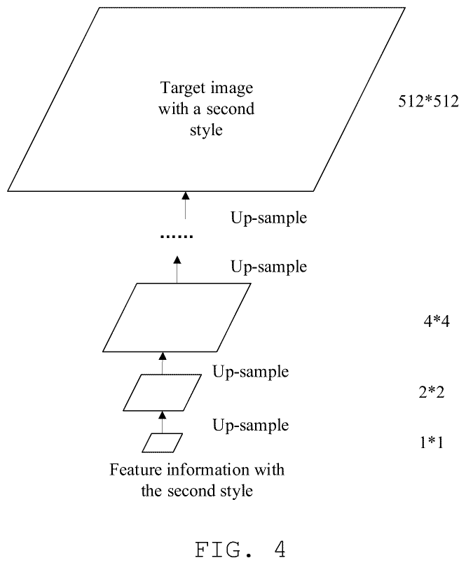

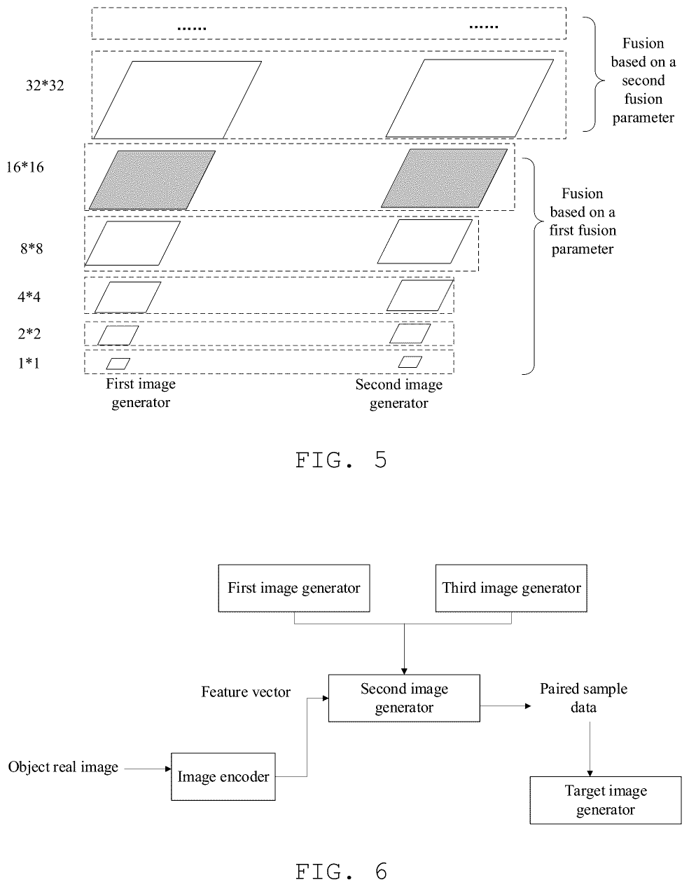

For example, as shown in FIG. 5, taking a target resolution of 16*16 as an example, each network parameter of the first image generator corresponding to a resolution less than or equal to 16*16 and each network parameter of the third image generator corresponding to a resolution less than or equal to 16*16 are fused, and each network parameter of the first image generator corresponding to a resolution greater than 16*16 and each network parameter of the third image generator corresponding to a resolution greater than 16*16 are fused. The fused network layer can not only achieve real face conversion based on the input feature information, but also obtain an image with the second style based on the input feature information. The fusion of the two generators ensures that the corresponding network layer can output feature information that has both the second style and the second style.

In an embodiment of the present disclosure, as shown in FIG. 6, after training the first image generator and the third image generator, the first image generator and the third image generator are fused to obtain a second image generator having both the first style and the second style. The second image generator can output a target object image presenting both the first and second styles based solely on a relevant feature vector, without the need to construct an object real image with the second style in an actual scene. In the embodiment, to further enhance the realism of the paired sample data, the relevant feature vector can be obtained by an image encoder that extracts a feature from the object real image. Since the relevant feature vector is derived from the object real image, it is ensured that the output effect of the trained target image generator is more natural.

In step 102, an input sample feature vector is processed based on the first image generator and the second image generator to generate a sample image with the first style and a sample image with the second style as paired sample data.

In the embodiment, an input sample feature vector is processed based on the first image generator and the second image generator to generate a sample image with the first style and a sample image with the second style as paired sample data.

In step 103, a preset model is trained based on the paired sample data to generate a target image generator, wherein the target image generator is configured to process an input image with the first style to generate an output image with the second style.

In the embodiment, a preset model is trained by using the paired sample data to generate a target image generator. The target image generator is configured to process an input image to generate an output image that matches the second style, ensuring the naturalness and efficiency of image conversion for the target style.

In an embodiment of the present disclosure, if the target image generator is a GAN (Generative Adversarial Network), a parameter of a generative adversarial network can be trained using the paired sample data by supervised learning to generate the target image generator. During the training, in order to further ensure the similarity between an output image with the second style and an input image with the first style (for example, if the target object is a face, the output image with the second style and the input image with the first style would look more like the same person), the image textures of the paired sample data are weighted and fused according to preset weights during the training process to adjust the texture of the output image. The preset weights can be calibrated based on experimental data to ensure that the texture of the output image is closer to the texture of the input image with the first style, while also taking into account the texture with the second style.

In an embodiment of the present disclosure, in order to further ensure the similarity between the output image with the second style and the input image with the first style, it is also possible to obtain texture information of a background image and other entities such as hair, glasses, clothing, etc. in the input image with the first style, and to map the texture information to the corresponding image with the second style.

Since the facial feature vector used for training comes from an object real image, the generated paired sample data is relatively realistic. On the basis of improving the efficiency of obtaining the paired sample data, the quality of the paired sample data can be ensured. The target image generator generated by training a preset model using the paired sample data can be applied in intelligent terminals or the like, thereby overcoming the problem of difficult construction of training sample data and poor style conversion effect, and achieving lightweight image style conversion.

In summary, the image processing method provided in the embodiment of the present disclosure comprises training a first image generator that can generate a target object image with a first style based on an input random feature vector, and training a second image generator that can generate a target object image with a second style based on an input random feature vector; processing an input sample feature vector based on the first image generator and the second image generator respectively to generate a sample image with the first style and a sample image with the second style as paired sample data, so as to ensure the quality of the paired sample data on the basis of improving the efficiency of obtaining the paired sample dataset; and generating a target image generator by training a preset model using the paired sample data, the target image generator being configured to process an input image to generate an output image that matches the second style. As a result, the construction of high-quality paired sample data in style conversion scenes is achieved, which can overcome the problem of difficult sample data acquisition and can ensure the effect of image style conversion as much as possible, thereby improving the efficiency of image style conversion.

As mentioned in the above embodiment, the preparation of the paired sample data is of great importance to the final style conversion effect. Therefore, in an embodiment of the present disclosure, the quality of the constructed paired sample data is also ensured.

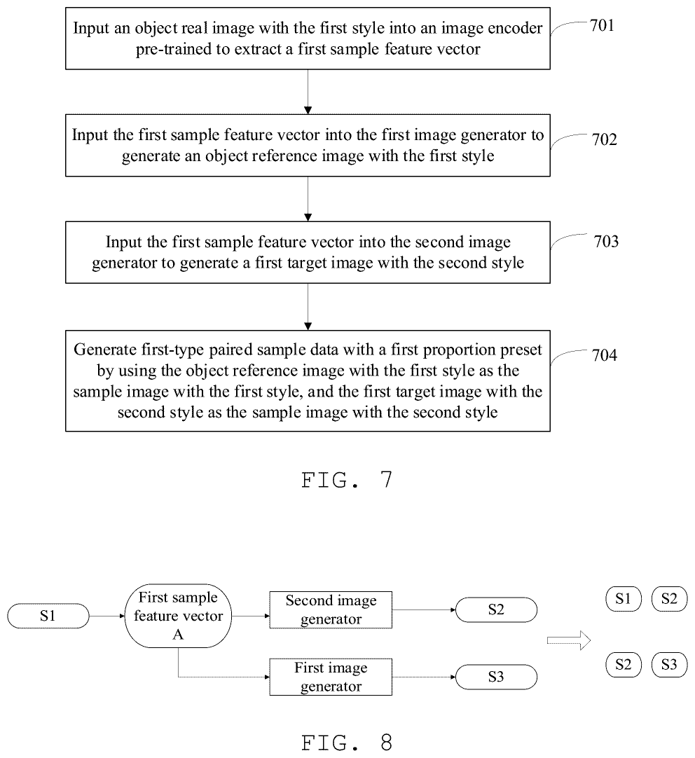

In an embodiment of the present disclosure, as shown in FIG. 7, the generating of the sample image with the first style and the sample image with the second style as paired sample data comprises steps 701 to 704.

In step 701, an object real image with the first style is input into an image encoder pre-trained to extract a first sample feature vector.

In step 702, the first sample feature vector is input into the first image generator to generate an object reference image with the first style.

In the embodiment, an object real image with the first style is input into an image encoder pre-trained to extract a first sample feature vector, and then the first sample feature vector is input into the first image generator to generate an object reference image with the first style. The object reference image is generated based on a feature vector of the object real image with the first style, so the object reference image has a close relationship with a real object and can be used as sample data later.

In step 703, the first sample feature vector is input into the second image generator to generate a first target image with the second style.

In the embodiment, the first sample feature vector is input into the second image generator to generate a first target image with the second style. Since the first target image is also obtained based on the first sample feature vector, the first target image has a close relationship with the real object and can be used as sample data later.

In step 704, first-type paired sample data with a first proportion preset is generated by using the object reference image with the first style as the sample image with the first style, and the first target image with the second style as the sample image with the second style.

In the embodiment, the first-type paired sample data with a first proportion preset is generated by using the object reference image with the first style as the sample image with the first style, and the first target image with the second style as the sample image with the second style, wherein the first proportion can be calibrated based on experimental data.

As shown in FIG. 8, a first sample feature vector A is input into the second image generator to generate a first target image S2 with the second style corresponding to an object real image S1. The first sample feature vector A is input into the first image generator to generate a reference face image S3 corresponding to the object real image. The generated paired face data set comprises: the object real image S1 and the first target image S2 with the second style corresponding to the object real image S1, as well as the reference face image S3 and the first target image S2 with the second style corresponding to the reference face image S3.

In some embodiments of the present disclosure, the method further comprises: generating a second-type paired sample data with a second proportion preset by using the object real image with the first style as the sample image with the first style, and the first target image with the second style as the sample image with the second style. That is, the sample image with the first style and the sample image with the second style are used as paired samples, i.e., the first target image S2 with the second style corresponding to the object real image S1 is used as paired sample data.

In some embodiments of the present disclosure, the method further comprises: inputting a second sample feature vector randomly generated into the first image generator to generate an object random image with the first style; and inputting the second sample feature vector into the second image generator to generate a second target image with the second style. In the embodiment, the object random image and the second target image with the second style corresponding to the object random image can also be used as paired sample data. The method further comprises: generating a third-type paired sample data with a third proportion preset by using the object random image with the first style as the sample image with the first style, and the second target image with the second style as the sample image with the second style. A sum of the first proportion, the second proportion and the third proportion is 1, and the proportion values can be calibrated according to the needs of application scenes. In some possible embodiments, the first proportion may be 30%, the second proportion may be 50%, and the third proportion may be 20%.

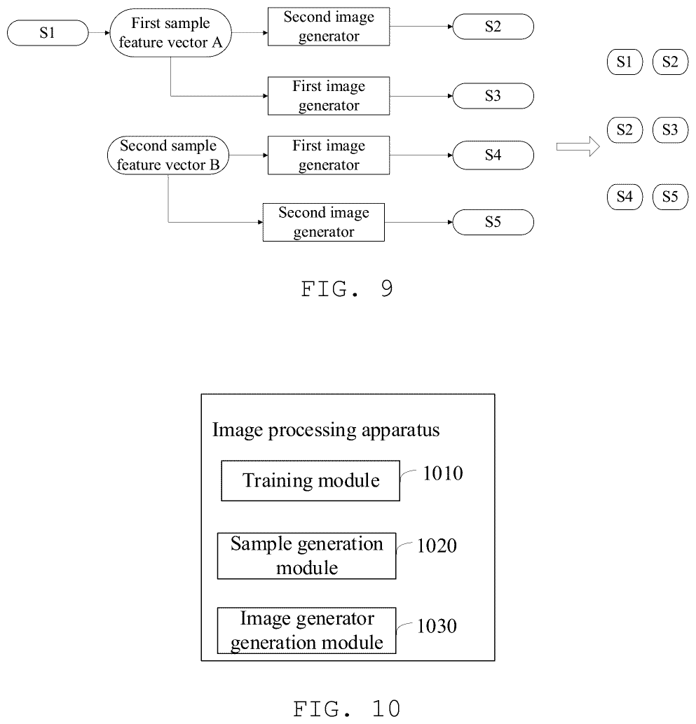

Taking the scene shown in FIG. 8 as an example, as shown in FIG. 9, the first sample feature vector A is input into the second image generator to generate a first target image S2 with the second style corresponding to the object real image S1. The first sample feature vector A is input into the first image generator to generate an object reference image S3 with the first style. A second sample feature vector B randomly generated can also be input into the first image generator to generate an object random image S4. The second sample feature vector B is input into the second image generator to generate a second target image S5 with the second style corresponding to the second sample feature vector. The generated paired sample data comprises: the object random image S4 and the second target image S5 corresponding to the object random image S4 which are collected according to the first proportion preset; the object real image S1 and the first target image S2 with the second style corresponding to the object real image S1 which are collected according to the second proportion preset; and the object reference image S3 and the first target image S2 with the second style corresponding to the object reference image S3 which are collected according to the third proportion preset.

Similarly, in order to ensure the similarity between the output image with the second style and the input image with the first style or the object reference image, in the embodiment, deformation compensation processing is also performed on a difference part of a facial key point between the paired images of the paired sample data. For example, the facial key points are identified; a scaling ratio value and a rotation angle are generated based on an angle and a distance between the facial key points on the paired images (i.e., the sample image with the first style and the sample image with the second style in the paired sample data); the sample image with the second style is adjusted based on the scaling ratio value and the rotation angle, so that the sample image with the second style in the paired sample data is similar to the corresponding sample image with the first style.

Mapping compensation processing is also performed on a difference part of a non-facial key point between the paired images of the paired sample data (i.e., the sample image with the first style and the sample image with the second style in the paired sample data). The non-facial key point comprises, but is not limited to, a facial decoration such as glasses on the face, beards, and an image background. Therefore, based on contour detection or other methods, an image region with a difference part can be cut out and mapped to the corresponding sample image with the second style.

In summary, in the image processing method of the embodiment of the present disclosure, paired sample data can be generated based on a relevant image generator and the second image generator without the need for manual shooting to generate corresponding paired images, so that automatic acquisition of paired sample data can be achieved, which provides technical support for improving image style conversion effect and efficiency.

In order to implement the above embodiment, the present disclosure further provides an image processing apparatus.

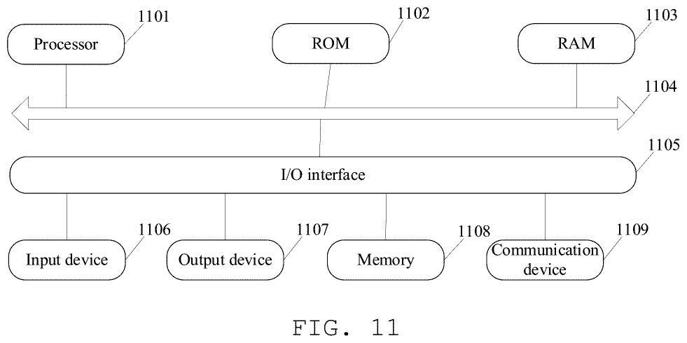

FIG. 10 is a schematic structural diagram of an image processing apparatus provided by an embodiment of the present disclosure. The apparatus can be realized by software and/or hardware and can generally be integrated into an electronic device to achieve facial image processing. As shown in FIG. 10, the apparatus comprises: a training module 1010, a sample generation module 1020, and an image generator generation module 1030.

The training module 1010 is configured to generate a first image generator by training, and generate a second image generator by training, wherein the first image generator is configured to process an input random feature vector to generate a target object image with a first style, and the second image generator is configured to process the input random feature vector to generate a target object image with a second style.

The sample generation module 1020 is configured to process an input sample feature vector based on the first image generator and the second image generator to generate a sample image with the first style and a sample image with the second style as paired sample data.

The image generator generation module 1030 is configured to train a preset model based on the paired sample data to generate a target image generator, wherein the target image generator is configured to process an input image with the first style to generate an output image with the second style.

The image processing apparatus provided by the embodiment of the present disclosure can perform the image processing method provided by any embodiment of the present disclosure, and has corresponding functional modules to implement the method and the beneficial effects.

In order to implement the above embodiment, the present disclosure further provides a computer program product comprising a computer program/instructions that, when executed by a processor, implement the image processing method provided by the above embodiment.

FIG. 11 is a schematic structural diagram of an electronic device provided by an embodiment of the present disclosure.

Referring to FIG. 11, a schematic structural diagram of an electronic device suitable for implementing the embodiments of the present disclosure is shown. The electronic device in the embodiment of the present disclosure may comprise, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), and a fixed terminal such as a digital TV, a desktop computer, and the like. The electronic device shown in FIG. 11 is merely an example and should not impose any limitation on the function and scope of the embodiments of the present disclosure.

As shown in FIG. 11, the electronic device may comprise a processor (e.g., a central processing unit, a graphics processor, or the like) 1101, which may perform various appropriate actions and processes according to a program stored in Read Only Memory (ROM) 1102 or a program loaded from storage device 1108 into Random Access Memory (RAM) 1103. In RAM 1103, various programs and data required for the operation of the electronic device are also stored. The processor 1101, ROM 1102, and RAM 1103 are connected to each other through a bus 1104. An input/output (I/O) interface 1105 is also connected to the bus 1104.

Generally, the following devices can be connected to the I/O interface 1105: an input device 1106 comprising, for example, a touch screen, a touch pad, a keyboard, a mouse, a camera, a microphone, an accelerometer, a gyroscope, etc.; an output device 1107 comprising a liquid crystal display (LCD), a speaker, a vibrator, etc.; a memory 1108 such as a magnetic tape, a hard disk, etc.; and a communication device 1109. The communication device 1109 enables the electronic device 600 to communicate with other devices to exchange data in a wireless or wired manner. Although FIG. 11 shows the electronic device with various components, it should be understood that it is not required to implement or have all of these components. Alternatively, more or fewer components can be implemented or provided.

In particular, according to an embodiment of the present disclosure, the processes described above with reference to the flowchart can be implemented as a computer software program. For example, an embodiment of the present disclosure comprises a computer program product, which comprises a computer program carried on a non-transitory computer readable medium, and containing program code for executing the method shown in the flowchart. In such an embodiment, the computer program may be downloaded and installed from the network through the communication device 1109, or installed from the memory 1108, or from the ROM 1102. When the computer program is executed by the processor 1101, the above functions defined in the image processing method according to the embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks comprise a local area network (“LAN”) and a wide area network (“WAN”), the Internet, and end-to-end networks (for example, ad hoc end-to-end networks), as well as any currently known or future developed networks.

The above computer readable medium may be comprised in the electronic device described above; or it may exist alone without being assembled into the electronic device.

The computer readable medium carries one or more programs that, when executed by the electronic device, cause the electronic device to: train a first image generator that can obtain a target object image with a first style based on an input random feature vector, and train a second image generator that can generate a target object image with a second style based on the input random feature vector; processing an input sample feature vector based on the first image generator and the second image generator respectively to generate a sample image with the first style and a sample image with the second style as paired sample data, so as to ensure the quality of the paired sample data on the basis of improving the efficiency of obtaining the paired sample dataset; and generating a target image generator by training a preset model using the paired sample data, the target image generator being configured to process an input image to generate an output image that matches the second style. As a result, the construction of high-quality paired sample data in a style conversion scene is achieved, which can overcome the problem of difficult sample data acquisition and can ensure the effect of image style conversion, thereby improving the efficiency of image style conversion.

The computer program code for executing operations of the present disclosure may be written in one or more program design languages or their combinations, the program design languages comprising but not limited to object-oriented program design languages, such as Java, Smalltalk, C++, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the case involving a remote computer, the remote computer may be connected to the user computer through various kinds of networks, comprising local area network (LAN) or wide area network (WAN), or connected to external computer (for example using an internet service provider via Internet).

The flowcharts and block diagrams in the drawings illustrate the architecture, functions and operations of possible implementations of systems, methods and computer program products according to various embodiments of the present disclosure. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the drawings. For example, two blocks shown in succession may be executed substantially in parallel, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the embodiment of the present disclosure can be implemented in software or hardware. The names of the units do not constitute a limitation on the units themselves under certain circumstances.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of thereof. More specific examples of the machine-readable storage medium may comprise electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

According to one or more embodiments of the present disclosure, the present disclosure provides an image processing method, comprising: generating a first image generator by training, and generating a second image generator by training, wherein the first image generator is configured to process an input random feature vector to generate a target object image with a first style, and the second image generator is configured to process the input random feature vector to generate a target object image with a second style; processing an input sample feature vector based on the first image generator and the second image generator to generate a sample image with the first style and a sample image with the second style as paired sample data; and training a preset model based on the paired sample data to generate a target image generator, wherein the target image generator is configured to process an input image with the first style to generate an output image with the second style.

According to one or more embodiments of the present disclosure, in the image processing method provided by the present disclosure, the generating of the first image generator by training comprises: randomly collecting first object image data with the first style based on a plurality of first preset indicators; and training a parameter of a generative adversarial network based on the first object image data to obtain the first image generator.

According to one or more embodiments of the present disclosure, in the image processing method provided by the present disclosure, the plurality of first preset indicators correspond to a plurality of feature dimensions of a target object.

According to one or more embodiments of the present disclosure, in the image processing method provided by the present disclosure, the generating of the second image generator by training comprises: collecting second object image data with the second style based on a plurality of second preset indicators; training a network parameter of the first image generator by using the second object image data to obtain a third image generator; determining a first network corresponding to an image resolution less than or equal to a target image resolution and a second network corresponding to an image resolution greater than the target image resolution in the first image generator during a process of up-sampling input feature information by the first image generator; determining a third network corresponding to an image resolution less than or equal to the target image resolution and a fourth network corresponding to an image resolution greater than the target image resolution in the third image generator during a process of up-sampling the input feature information by the third image generator; and fusing the first network with the third network based on a first fusion parameter preset and fusing the second network with the fourth network based on a second fusion parameter preset to obtain the second image generator.

According to one or more embodiments of the present disclosure, in the image processing method provided by the present disclosure, the plurality of second preset indicators correspond to a plurality of different dimensions of the second object image data.

According to one or more embodiments of the present disclosure, in the image processing method provided by the present disclosure, the processing of the input sample feature vector based on the first image generator and the second image generator to generate the sample image with the first style and the sample image with the second style as the paired sample data comprises: inputting an object real image with the first style into an image encoder pre-trained to extract a first sample feature vector; inputting the first sample feature vector into the first image generator to generate an object reference image with the first style; inputting the first sample feature vector into the second image generator to generate a first target image with the second style; and generating first-type paired sample data with a first proportion preset by using the object reference image with the first style as the sample image with the first style, and the first target image with the second style as the sample image with the second style.

According to one or more embodiments of the present disclosure, the image processing method provided by the present disclosure further comprises: generating a second-type paired sample data with a second proportion preset by using the object real image with the first style as the sample image with the first style, and the first target image with the second style as the sample image with the second style.

According to one or more embodiments of the present disclosure, the image processing method provided by the present disclosure further comprises: inputting a second sample feature vector randomly generated into the first image generator to generate an object random image with the first style; inputting the second sample feature vector into the second image generator to generate a second target image with the second style; and generating a third-type paired sample data with a third proportion preset by using the object random image with the first style as the sample image with the first style, and the second target image with the second style as the sample image with the second style.

According to one or more embodiments of the present disclosure, in the image processing method provided by the present disclosure, a sum of the first proportion, the second proportion and the third proportion is 1.

According to one or more embodiments of the present disclosure, the image processing method provided by the present disclosure further comprises: training a parameter of an image encoder based on object image data with the first style and the first image generator to extract a feature vector corresponding to an input real image from the input real image based on the image encoder trained.

According to one or more embodiments of the present disclosure, the image processing method provided by the present disclosure further comprises: performing deformation compensation on a difference part of a facial key point between the sample image with the first style and the sample image with the second style in the paired sample data; and/or performing mapping compensation on a difference part of a non-facial key point between the sample image with the first style and the sample image with the second style in the paired sample data.

According to one or more embodiments of the present disclosure, in the image processing method provided by the present disclosure, the training of the preset model based on the paired sample data to generate the target image generator comprises: training a parameter of a generative adversarial network based on the paired sample data by supervised learning to generate the target image generator, wherein image textures of the sample image with the first style and the sample image with the second style are weighted and fused according to preset weights during a training process to adjust an image texture of the output image.

According to one or more embodiments of the present disclosure, in the image processing method provided by the present disclosure, the input random feature vector comprises at least one of a contour feature or a pixel color feature.

According to one or more embodiments of the present disclosure, the present disclosure provides an image processing apparatus, comprising: a training module configured to generate a first image generator by training, and generate a second image generator by training, wherein the first image generator is configured to process an input random feature vector to generate a target object image with a first style, and the second image generator is configured to process the input random feature vector to generate a target object image with a second style; a sample generation module configured to process an input sample feature vector based on the first image generator and the second image generator to generate a sample image with the first style and a sample image with the second style as paired sample data; and an image generator generation module configured to train a preset model based on the paired sample data to generate a target image generator, wherein the target image generator is configured to process an input image with the first style to generate an output image with the second style.

According to one or more embodiments of the present disclosure, in the image processing apparatus provided by the present disclosure, the training module is configured to: randomly collect first object image data with the first style based on a plurality of first preset indicators; and train a parameter of a generative adversarial network based on the first object image data to obtain the first image generator.

According to one or more embodiments of the present disclosure, in the image processing apparatus provided by the present disclosure, the training module is configured to: collect second object image data with the second style based on a plurality of second preset indicators; train a network parameter of the first image generator by using the second object image data to obtain a third image generator; determine a first network corresponding to an image resolution less than or equal to a target image resolution and a second network corresponding to an image resolution greater than the target image resolution in the first image generator during a process of up-sampling input feature information by the first image generator; determine a third network corresponding to an image resolution less than or equal to the target image resolution and a fourth network corresponding to an image resolution greater than the target image resolution in the third image generator during a process of up-sampling the input feature information by the third image generator; and fuse the first network with the third network based on a first fusion parameter preset and fuse the second network with the fourth network based on a second fusion parameter preset to obtain the second image generator.

According to one or more embodiments of the present disclosure, in the image processing apparatus provided by the present disclosure, the sample generation module is configured to: input an object real image with the first style into an image encoder pre-trained to extract a first sample feature vector; input the first sample feature vector into the first image generator to generate an object reference image with the first style; input the first sample feature vector into the second image generator to generate a first target image with the second style; and generate first-type paired sample data with a first proportion preset by using the object reference image with the first style as the sample image with the first style, and the first target image with the second style as the sample image with the second style.

According to one or more embodiments of the present disclosure, in the image processing apparatus provided by the present disclosure, the sample generation module is configured to: generate a second-type paired sample data with a second proportion preset by using the object real image with the first style as the sample image with the first style, and the first target image with the second style as the sample image with the second style.

According to one or more embodiments of the present disclosure, in the image processing apparatus provided by the present disclosure, the sample generation module is configured to: input a second sample feature vector randomly generated into the first image generator to generate an object random image with the first style; input the second sample feature vector into the second image generator to generate a second target image with the second style; and generate a third-type paired sample data with a third proportion preset by using the object random image with the first style as the sample image with the first style, and the second target image with the second style as the sample image with the second style.

According to one or more embodiments of the present disclosure, in the image processing apparatus provided by the present disclosure, the image generator generation module is configured to: train a parameter of an image encoder based on object image data with the first style and the first image generator to extract a feature vector corresponding to an input real image from the input real image based on the image encoder trained.

According to one or more embodiments of the present disclosure, the image processing apparatus provided by the present disclosure further comprises: a compensation processing module configured to perform deformation compensation on a difference part of a facial key point between the sample image with the first style and the sample image with the second style in the paired sample data, and/or perform mapping compensation on a difference part of a non-facial key point between the sample image with the first style and the sample image with the second style in the paired sample data.

According to one or more embodiments of the present disclosure, in the image processing apparatus provided by the present disclosure, the image generator generation module is configured to: train a parameter of a generative adversarial network based on the paired sample data by supervised learning to generate the target image generator, wherein image textures of the sample image with the first style and the sample image with the second style are weighted and fused according to preset weights during a training process to adjust an image texture of the output image.

According to one or more embodiments of the present disclosure, the present disclosure provides an electronic device, comprising: a processor; a memory configured to store executable instructions for the processor; wherein the processor is configured to read the executable instructions from the memory and execute the executable instructions to implement the image processing method of any one of above embodiments.

According to one or more embodiments of the present disclosure, the present disclosure further provides a computer-readable storage medium (e.g., a non-transitory computer-readable storage medium) on which a computer program is stored, wherein the computer program is configured to perform the image processing method of any one of above embodiments.

According to one or more embodiments of the present disclosure, the present disclosure provides a computer program, comprising: instructions that, when executed by a processor, cause the processor to perform the image processing method of any one of above embodiments.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. An image processing method, comprising:
generating a first image generator by training, and generating a second image generator by training, wherein the first image generator is configured to process an input random feature vector to generate a target object image with a first style, and the second image generator is configured to process the input random feature vector to generate a target object image with a second style;
processing an input sample feature vector based on the first image generator and the second image generator to generate a sample image with the first style and a sample image with the second style as paired sample data; and
training a preset model based on the paired sample data to generate a target image generator, wherein the target image generator is configured to process an input image with the first style to generate an output image with the second style.

2. The image processing method according to claim 1, wherein the generating of the first image generator by training comprises:
randomly collecting first object image data with the first style based on a plurality of first preset indicators; and
training a parameter of a generative adversarial network based on the first object image data to obtain the first image generator.

3. The image processing method according to claim 2, wherein the plurality of first preset indicators correspond to a plurality of feature dimensions of a target object.

4. The image processing method according to claim 1, wherein the generating of the second image generator by training comprises:
collecting second object image data with the second style based on a plurality of second preset indicators;
training a network parameter of the first image generator by using the second object image data to obtain a third image generator;
determining a first network corresponding to an image resolution less than or equal to a target image resolution and a second network corresponding to an image resolution greater than the target image resolution in the first image generator during a process of up-sampling input feature information by the first image generator;
determining a third network corresponding to an image resolution less than or equal to the target image resolution and a fourth network corresponding to an image resolution greater than the target image resolution in the third image generator during a process of up-sampling the input feature information by the third image generator; and
fusing the first network with the third network based on a first fusion parameter preset and fusing the second network with the fourth network based on a second fusion parameter preset to obtain the second image generator.

5. The image processing method according to claim 4, wherein the plurality of second preset indicators correspond to a plurality of different dimensions of the second object image data.

6. The image processing method according to claim 1, wherein the processing of the input sample feature vector based on the first image generator and the second image generator to generate the sample image with the first style and the sample image with the second style as the paired sample data comprises:
inputting an object real image with the first style into an image encoder pre-trained to extract a first sample feature vector;
inputting the first sample feature vector into the first image generator to generate an object reference image with the first style;
inputting the first sample feature vector into the second image generator to generate a first target image with the second style; and
generating first-type paired sample data with a first proportion preset by using the object reference image with the first style as the sample image with the first style, and the first target image with the second style as the sample image with the second style.

7. The image processing method according to claim 6, further comprising:
generating a second-type paired sample data with a second proportion preset by using the object real image with the first style as the sample image with the first style, and the first target image with the second style as the sample image with the second style.

8. The image processing method according to claim 7, further comprising:
inputting a second sample feature vector randomly generated into the first image generator to generate an object random image with the first style;
inputting the second sample feature vector into the second image generator to generate a second target image with the second style; and
generating a third-type paired sample data with a third proportion preset by using the object random image with the first style as the sample image with the first style, and the second target image with the second style as the sample image with the second style.

9. The image processing method according to claim 8, wherein a sum of the first proportion, the second proportion and the third proportion is 1.

10. The image processing method according to claim 4, further comprising:
training a parameter of an image encoder based on object image data with the first style and the first image generator to extract a feature vector corresponding to an input real image from the input real image based on the image encoder trained.

11. The image processing method according to claim 1, further comprising:
performing deformation compensation on a difference part of a facial key point between the sample image with the first style and the sample image with the second style in the paired sample data; and/or
performing mapping compensation on a difference part of a non-facial key point between the sample image with the first style and the sample image with the second style in the paired sample data.

12. The image processing method according to claim 1, wherein the training of the preset model based on the paired sample data to generate the target image generator comprises:
training a parameter of a generative adversarial network based on the paired sample data by supervised learning to generate the target image generator, wherein image textures of the sample image with the first style and the sample image with the second style are weighted and fused according to preset weights during a training process to adjust an image texture of the output image.

13. The image processing method according to claim 1, wherein the input random feature vector comprises at least one of a contour feature or a pixel color feature.

14. (canceled)

15. An electronic device, comprising:
a processor; and
a memory configured to store executable instructions for the processor;
wherein the processor is configured to read the executable instructions from the memory and execute the executable instructions to:
generate a first image generator by training, and generate a second image generator by training, wherein the first image generator is configured to process an input random feature vector to generate a target object image with a first style, and the second image generator is configured to process the input random feature vector to generate a target object image with a second style;
process an input sample feature vector based on the first image generator and the second image generator to generate a sample image with the first style and a sample image with the second style as paired sample data; and
train a preset model based on the paired sample data to generate a target image generator, wherein the target image generator is configured to process an input image with the first style to generate an output image with the second style.

16. A non-transitory computer-readable storage medium on which a computer program is stored, wherein the computer program is configured to:
generate a first image generator by training, and generate a second image generator by training, wherein the first image generator is configured to process an input random feature vector to generate a target object image with a first style, and the second image generator is configured to process the input random feature vector to generate a target object image with a second style;
process an input sample feature vector based on the first image generator and the second image generator to generate a sample image with the first style and a sample image with the second style as paired sample data; and
train a preset model based on the paired sample data to generate a target image generator, wherein the target image generator is configured to process an input image with the first style to generate an output image with the second style.

17. (canceled)

18. The electronic device according to claim 15, wherein the processor is configured to read the executable instructions from the memory and execute the executable instructions to:
randomly collect first object image data with the first style based on a plurality of first preset indicators; and
train a parameter of a generative adversarial network based on the first object image data to obtain the first image generator.

19. The electronic device according to claim 18, wherein the plurality of first preset indicators correspond to a plurality of feature dimensions of a target object.

20. The electronic device according to claim 15, wherein the processor is configured to read the executable instructions from the memory and execute the executable instructions to:
collect second object image data with the second style based on a plurality of second preset indicators;
train a network parameter of the first image generator by using the second object image data to obtain a third image generator;
determine a first network corresponding to an image resolution less than or equal to a target image resolution and a second network corresponding to an image resolution greater than the target image resolution in the first image generator during a process of up-sampling input feature information by the first image generator;
determine a third network corresponding to an image resolution less than or equal to the target image resolution and a fourth network corresponding to an image resolution greater than the target image resolution in the third image generator during a process of up-sampling the input feature information by the third image generator; and
fuse the first network with the third network based on a first fusion parameter preset and fuse the second network with the fourth network based on a second fusion parameter preset to obtain the second image generator.

21. The non-transitory computer-readable storage medium according to claim 16, wherein the computer program is configured to:
randomly collect first object image data with the first style based on a plurality of first preset indicators; and
train a parameter of a generative adversarial network based on the first object image data to obtain the first image generator.

22. The non-transitory computer-readable storage medium according to claim 21, wherein the plurality of first preset indicators correspond to a plurality of feature dimensions of a target object.
